(19) United States
(12) Patent Application Publication
(10) Pub. No.: US 2024/0201771 A1
(43) Pub. Date: Jun. 20, 2024

(54) METHOD AND APPARATUS FOR DETECTING IMMINENT USE OF AN ELECTRONIC DEVICE

(71) Applicant: Ecolink Intelligent Technology, Inc., Carlsbad, CA (US)

(72) Inventors: Jay Stone, San Marcos, CA (US); Michael Archbold, San Marcos, CA (US)

(21) Appl. No.: 18/080,836

(22) Filed: Dec. 14, 2022

(51) Int. Cl. G06F 1/3231; G01J 5/00; G01J 5/02; G01J 5/0831

(52) U.S. Cl. CPC G06F 1/3231; G01J 5/0025; G01J 5/0275; G01J 5/0831

(57) ABSTRACT

An apparatus and method for determining imminent use of an electronic device. An infrared sensor is used to determine when a human hand is approaching the electronic device and breaches an activation distance. The infrared sensor is partially covered by a mask having a mask opening formed therethrough so that only a portion of ambient light reaches the infrared sensor. When the infrared sensor comprises two or more sensing elements, each sensing element is completely masked while one sensing element is partially masked, thereby allowing only one sensing element to receive ambient light. Signals from the infrared sensor are processed to determine when a human hand is approaching the electronic device and breaches the activation distance. When detected, the electronic device self-illuminates in order to make it easier for a person to interact with the electronic device.

### BACKGROUND

### I. Field of Use

The present application relates generally to home monitoring, automation and security. More specifically, embodiments of the present invention relate to a method and apparatus for detecting imminent use of an electronic device used in home monitoring, automation and security applications.

### II. Description of the Related Art

Home monitoring, automation and security has been gaining popularity in recent years, allowing homeowners to monitor and control various devices and systems in their homes. For example, a wide variety of smart thermostats, smart lighting products, security systems, and other consumer electronic devices have been adopted by millions of households to date. For example, Google's Nest thermostat has revolutionized the home thermostat market by intelligently learning the usage habits of home occupants, while also allowing remote control of the thermostat via the Internet. Wi-Fi enabled light bulbs are becoming increasingly common, allowing remote control and monitoring of lights. A variety of other remote-control devices are available, including devices that open/close garage doors, turn on/off pool/spa equipment, turn on/off sprinkler systems, etc.

In some cases, an electronic control device is associated with one or more of the aforementioned systems, such as a keypad to control a home security system or a thermostat to control an HVAC system. Such electronic control devices typically comprise a user interface that allows a user to interact with a system by physically interacting with the electronic control device. For example, a user of a thermostat may physically approach the thermostat and change a temperature setpoint by touching various icons displayed by a touch-sensitive screen.

In low light conditions, or in darkness, it is generally desirable to illuminate electronic devices, especially electronic control devices, prior to actual physical contact from a user in order to make an electronic device more visible to a user. For example, many thermostats and security keypads self-illuminate when an approaching human hand is detected. Technologies such as infrared (IR), ultrasonic or capacitance have been used to detect a user's approaching hand in varying degrees of success.

Detection of a user's approaching hand is even more challenging when an electronic device is battery powered, as the above-mentioned prior art technologies may be relatively power-intensive, requiring users to change batteries more often than desired.

Moreover, the above-mentioned prior art detecting technologies typically suffer from some degree of false positive and/or false negative determinations. For example, illumination of a prior-art electronic control device may be triggered simply as a person walks past it. Or, a prior-art electronic control device may not reliably detect a user's approaching hand each time, especially as ambient lighting conditions vary throughout the day and night.

It would be desirable, therefore, to be able to reliably detect imminent use of an electronic device a battery-efficient manner, and to avoid false alarms when people are in proximity to, but do not reach for, such electronic devices.

### SUMMARY

The embodiments described herein relate to apparatus and methods for determining imminent use of an electronic device. In one embodiment, an apparatus is described, comprising an infrared sensor for detecting a change of infrared energy within an activation distance from the electronic device, the activation distance comprising a distance where a user's hand is detected as it approaches the electronic device, a processor coupled to the infrared sensor, for receiving an electronic signal from the infrared sensor indicative of the change of infrared energy, for determining that the electronic signal comprises an indication of imminent use of the electronic device, and for activating an illumination device in response thereto, and the illumination device, coupled to the processor, for illuminating the electronic device when the processor has determined imminent use of the electronic device.

In another embodiment, a method is described for determining imminent use of an electronic device using a digital infrared sensor, comprising limiting an amount of ambient light that falls on the infrared sensor with a mask, the mask comprising a mask opening that allows some ambient light to fall on a first sensing element of the infrared sensor, the mask opening sized to define an activation distance in front of the electronic device that, when breached by a human hand, causes an electronic signal to be generated by the infrared sensor, receiving the electronic signal by the processor, and in response to receiving the electronic signal, causing one or more illumination devices to illuminate the electronic device.

In yet another embodiment, a method is described for determining imminent use of an electronic device using a passive pyroelectric sensor, comprising, limiting an amount of ambient light that falls on the passive pyroelectric sensor with a mask, the mask comprising a mask opening that allows some ambient light to fall on the passive pyroelectric sensor, the mask opening sized to define an activation distance in front of the electronic device that, when breached by a human hand, causes the electronic device to become illuminated, generating an electric signal by the passive pyroelectric sensor in response to detecting a change in infrared energy, amplifying the electric signal to form an amplified signal, filtering the amplified electric signal to create a filtered signal, comparing the filtered signal to a threshold, determining that a human hand has breached the activation distance when the filtered signal exceeds the threshold, and in response to determining that the human hand has breached the activation distance, causing one or more illumination devices located on or within the electronic device to illuminate the electronic device.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a perspective view of one embodiment of an electronic control device embodying the inventive concepts described herein, for detecting imminent use of the electronic control device;

FIG. 2A is a perspective view of one embodiment of an infrared sensor used in the electronic control device of FIG. 1;

FIG. 2B is a top, plan view of the infrared sensor as shown in FIG. 2A, more clearly showing two sensing elements in relation to a top surface of the infrared sensor;

FIG. 3 is a top, close-up, plan view of the infrared sensor as shown in FIGS. 2A and 2B, with a circular mask covering a majority of the top surface of the infrared sensor, the mask comprising a circular mask opening 302;

FIG. 4 is a close up, side view of one embodiment of the infrared sensor shown in FIGS. 2A and 2B mounted within a housing of the electronic control device shown in FIG. 1;

FIG. 5 is a functional block diagram of one embodiment of the electronic control device shown in FIG. 1;

FIG. 6 is a flow diagram illustrating one embodiment of a method, performed by the infrared sensor shown in FIGS. 2A, 2B and 3 a processor of the electronic control device, functionally shown in FIG. 5, for determining imminent use of the electronic control device shown in FIG. 1;

FIG. 7 is a flow diagram illustrating one embodiment of a method, performed by the processor shown functionally in FIG. 5, for determining imminent use of the electronic control device as shown in FIG. 1, in an embodiment where the infrared sensor comprises a pyroelectric sensor without any active components;

FIG. 8 is a flow diagram illustrating one embodiment of a method for manufacturing the electronic control device shown in FIG. 1; and

FIG. 9 is a close-up, front, plan view of a portion of the electronic control device shown in FIG. 1, highlighting the substantial alignment of a sensing element of the infrared sensor with a housing opening in the housing of the electronic control device, and the importance of accurate placement and/or orientation of the infrared sensor during the manufacturing process.

### DETAILED DESCRIPTION

An electronic device is described for detecting imminent use of the electronic device and, in response, performing one or more actions, such as to become self-illuminated, especially during low-light conditions or darkness. An infrared sensor is used to detect changes in infrared energy emanating from a human body and, more particularly, infrared energy emitted by a human hand as it approaches an electronic device in anticipation of using the electronic device. The infrared sensor is masked to limit the amount of ambient light that falls on the infrared sensor. By limiting the amount of ambient light that falls on the infrared sensor, the infrared sensor can make accurate determinations of imminent use of the electronic device by a user, i.e., determining when a human hand is approaching the electronic device within a predetermined “activation distance”, such as a distance of between 6 and 18 inches in front of the electronic device. Ambient light comprises one or more of natural sunlight, artificial light produced by indoor electric lighting and infrared light produced by any thermal radiation from, for example, warm-blooded animals, including humans.

One skilled in the art might consider using an infrared sensor to detect an approaching human hand within a short distance of an electronic device. However, infrared sensors have numerous limitations that normally render them useless in such applications.

Infrared sensors are typically used in motion detectors widely used in the home security industry. Typically, these motion detectors comprise either a passive pyroelectric sensor and processing circuitry, or an “active” or “digital” infrared sensor comprising a passive pyroelectric sensor and active circuitry for processing signals from the passive pyroelectric sensor. In either case, infrared sensors typically comprise two or more sensing elements or “channels”, with each pair of sensing elements out-of-phase with each other. This allows motion detectors to better detect changes in infrared energy as a thermal source moves across an area in front of a motion detector. Commercially-availability of digital, single-element infrared sensors is limited or non-existent.

Use of a multi-element infrared sensor to detect subtle movements within a limited range from an electronic device may result in poor performance, most likely from cancelation of the signals from the positive and negative sensing elements. The output may tend to be noisy. False triggers may be encountered (i.e., a person walking by at a distance of 3 feet) while intended motion (i.e., a person reaching for the electronic device) may be missed.

Infrared sensors are typically relatively sensitive, i.e., they can detect changes in infrared energy up to 50 feet or more. While this is generally a useful feature for motion detectors, the high sensitivity of most passive infrared sensors renders them unsuitable for use in detecting subtle motion (i.e., an approaching human hand vs. a human body) within a relatively small distance from an electronic device.

Additionally, infrared sensors typically require a number of Fresnel lenses to focus infrared energy of a thermal source onto a sensor and helps detect movement of the thermal source as the thermal sources moves across a field of view defined by each lens. The lenses are typically spaced away from an infrared sensor, for example, by an inch or more. This results in most motion detectors suffering from an unattractive, bulky design. Smaller Fresnel lenses are available that fit directly over infrared sensors, but this configuration may also result in false triggering and missed detections. In either case, use of a Fresnel lens adds undesired cost to an electronic device.

The above limitations with infrared sensors, i.e., high sensitively, limited/non-availability of single element sensors and the need for Fresnel lenses, typically do not make them suitable for use in detecting motion within a small distance from an electronic device, such as a human hand reaching out to operate a thermostat. However, the inventors of the subject matter of the present disclosure have found a way to use even multi-channel infrared sensors to detect such particular, up-close movement.

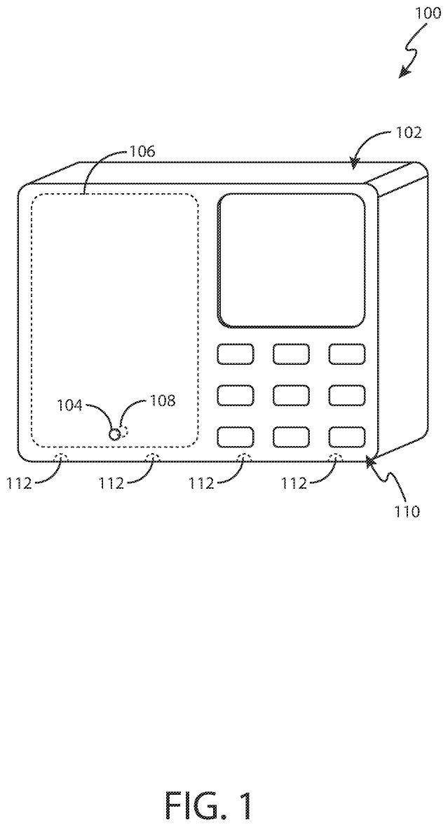

FIG. 1 is a perspective view of one embodiment of an electronic device 100 embodying the inventive concepts described herein. Shown is housing 102, housing aperture 104, circuit board 106, infrared sensor 108, user interface 110, and one or more illumination devices 112. Electronic device 100 is typically a battery-powered consumer device, located within easy reach of users, for example on a wall at shoulder height, such as a battery-operated thermostat, security system keypad, or a controller of one or more home or business monitoring and/or automation systems. The terms “electronic device” and “electronic control device” are used interchangeably herein, the latter referring to an electronic device that controls other electronic devices or systems, such as a thermostat that controls an HVAC system, a security key pad that controls a security system, a television remote control that controls a television, etc.

Housing 102 encases circuit board 106, which comprises a number of electronic components, including infrared sensor 106. Housing 102 typically comprises plastic or a similar low-cost, lightweight material typically used to construct consumer-grade electronics. In one embodiment, housing 102 comprises a thickness of about between 1 and 3 millimeters. In one embodiment, housing 102 comprises a material and/or thickness that greatly attenuates, or completely prevents, ambient light from entering inside housing 102.

Housing 102 comprises housing aperture 104 which allows ambient light in an area in front of electronic device 102 to illuminate a top surface of infrared sensor 108. Infrared sensor 108 is shown offset from housing aperture 104 in FIG. 1 due to the perspective nature of this figure. However, infrared sensor 108 is typically substantially aligned with housing aperture 104 when viewed directly in front of electronic device 102. Infrared sensor 108 is typically mounted to circuit board 106 such that the top surface of infrared sensor 108, or one of a plurality of sensing elements of infrared sensor 108 (shown and described later herein), is in substantial alignment with housing aperture 104. Housing aperture 104 is relatively small in size, typically comprising a diameter of 2 millimeters or less. In some embodiments, the diameter of housing aperture 104 is smaller than a diameter of the top surface of infrared sensor 108, in order to limit the amount of ambient light that falls on infrared sensor 108, acting as a mask. It should be understood that although housing aperture 104 is shown in FIG. 1 as a single hole, circular in shape, in other embodiments, the number of apertures and the shape of each one may be different than what is shown in FIG. 1 in other embodiments, for example, comprising a square, rectangle, triangle, etc. shape.

Infrared sensor 108 comprises either a passive, pyroelectric sensing element or a more sophisticated, integrated digital sensor comprising two or more pyroelectric sensing elements and internal circuitry to filter, amplify, and process electrical signals produced by the pyroelectric sensing elements. In either case, a mask (shown and described later herein) is used to limit the amount of ambient light falling on infrared sensor or, more particularly, one or more of the sensing elements. Limiting the amount of ambient light that reaches one or more sensing elements reduces the sensitivity of infrared sensor 108 to detect thermal energy and allows detection of an imminent use of electronic device 100 as a user's hand, for example, reaches towards electronic device 100 within a predetermined “activation distance” from electronic device 100. The activation distance is a distance where it is desirable to have electronic device perform at least one action in response to a human hand encroaching the activation distance. For example, the activation distance may be 12 inches and electronic device 100 is configured to self-illuminate via the one or more illumination devices 112 when a user's hand approaches electronic device 100 within 12 inches. A user's hand typically approaches electronic device 102 when a user desires to interact with electronic device 100 via user interface 110 and/or an associated electronic system, such as a HVAC system, a security system, etc. In FIG. 1, user interface 110 comprises a display and keypad, but in other embodiments, other components may be used. For example, the display and keypad may be replaced by a touch screen display device.

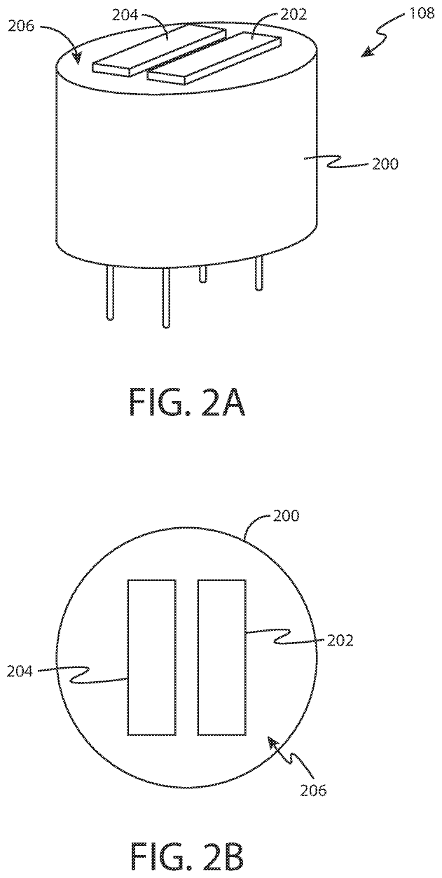

FIG. 2A is a perspective view of one embodiment of infrared sensor 108. In this embodiment, infrared sensor 108 comprises an integrated, dual element, digital pyro, such as model no. PYD 1598/7655, in a TO-5 “can”, manufactured by Excelitas Technologies of Waltham, Massachusetts. In this embodiment, infrared sensor 108 comprises housing 200 and two sensing elements 202 and 204 located on a top surface 206. Although each sensing element in this embodiment comprises a rectangular shape, in other embodiments, a sensing element may comprise a different shape, such as a circle, ellipse, square, etc. “Digital pyros”, such as the dual-element device shown in FIG. 2A, are popular today for use in battery-powered motion detectors, as they provide differential detection of infrared energy in a small, low-power device. Further, such digital pyros integrate desirable features such as filtering, amplification, digitization and sensing capabilities, avoiding the need to design external circuitry to achieve the same functionality.

Sensing elements 202 and 204 are typically wired in series with each other and electrically out of phase with one another such that any change in infrared energy detected by the sensing elements will result in a positive waveform from one sensing element and a negative waveform from the other sensing element. The resulting signal from the sensing elements is processed internally, in this embodiment, by amplifying, filtering and comparing the signal to a user-defined electrical threshold. An internal processor may generate a digital interrupt when the signal exceeds the threshold, indicating that motion was detected. In order to detect imminent use of electronic device 100, however, use of two sensing elements does not reliably detect an approaching human hand within a short, predetermined activation distance and, further, causes false detections, for example when a person walks by electronic device 100 within, for example, 3 feet. It has been discovered, however, that using a single sensing element and limiting the ambient light that falls onto the sensing element, allows accurate imminent detection of use of electronic device while limiting the number of false triggers. Unfortunately, commercial availability of single element infrared sensors is limited or non-existent. However, a mask may be used to prevent ambient light from reaching unused sensing elements, as well as to limit the amount of ambient light that reaches a selected sensing element in a multi-elements infrared sensor, as more fully discussed below.

FIG. 2B is a top, plan view of the particular infrared sensor 108 as shown in FIG. 2A, more clearly showing the sensing elements 202 and 204 in relation to top surface 206.

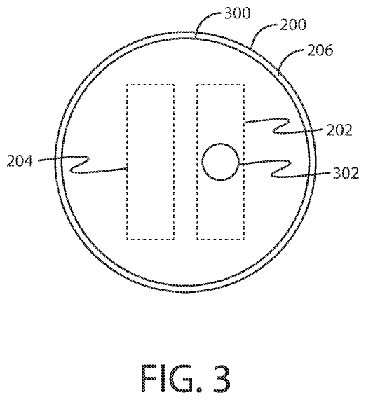

FIG. 3 is a top, close-up, plan view of the infrared sensor 108 as shown in FIGS. 2A and 2B, with a circular mask 300 covering a majority of top surface 206 and comprising a mask opening 302 positioned over a portion of sensing element 202. While shown as being circular, mask 300, in other embodiments, may comprise a different shape. Similarly, mask opening 302 may also comprise a different shape than the one shown in FIG. 3.

Mask 300 comprises a thin (typically less than 2 mm) material that is opaque at least to infrared light and typically opaque with respect to any light. Mask 300 is designed, in this embodiment, to fully cover one of the sensing elements, in this case, sensing element 204 and to partially cover another one of the sensing elements, in this example, sensing element 202. In embodiments where infrared sensor 108 comprises more than two sensing elements, mask 300 may cover all of the sensing elements, while partially exposing one of the sensing elements via mask opening 302.

Mask opening 302 is sized to allow a predetermined, limited amount of infrared light to strike sensing element 202 as it passes through housing aperture 104. By limiting the amount of infrared light that is received by sensing element 202, the sensitivity of infrared sensor 108 is greatly reduced. For example, without masking, infrared sensor 108 may be able to detect changes in infrared energy at a distance of five feet or more, which is undesirable when configuring electronic device 108 to become self-illuminated only upon imminent use of electronic device 100, i.e., when a user's hand is approaching electronic device 100. By completely masking all but one of the sensing elements and partially masking that sensing element, infrared sensor 108 is only able to detect changes in infrared energy within a short, predetermined distance from electronic device 100, such as approximately between 6 and 24 inches.

The size, or area, of mask opening 302 may directly influence the sensitivity of infrared sensor 108 and, therefore, electronic device 100, i.e., define the activation distance. For example, in FIG. 3, mask opening 302 is one millimeter in diameter, while the dimensions of sensing element 202 are one millimeter by two millimeters. It should be understood that the proportions of mask opening 302, housing 200 and each of the sensing elements may not be to scale in FIG. 3 or in proportion to one another. With these dimensions, mask opening 302 covers approximately 0.98 square millimeters of sensing element 202, or approximately 51% of sensing element 202. The sensitivity of sensing element 202 is typically reduced proportionately with the amount of surface area of sensing element 202 covered by mask 300, in this case, reduced by approximately 51 percent. By varying the area of mask opening 302, a desired activation distance may be achieved. For example, with mask opening 302 having a diameter of one millimeter, and sensing element 202 having an area of two square millimeters, an activation distance of 18 inches may be achieved. To increase the activation distance, mask opening 302 may be increased and vice-versa, or two or more mask openings 302 may be formed into mask 300 over one sensing element to increase the sensitivity of infrared sensor 108 and, accordingly, the activation distance.

In some embodiments, where infrared sensor 108 comprises active elements such as one or more filters, amplifiers, digital-to-analog converters, etc., the sensitivity of infrared sensor 108 and, thus, the activation distance, may additionally be adjusted by altering a digital voltage threshold used by infrared sensor 108 to determine detected thermal energy represents a human hand approaching electronic device 100 and to generate an interrupt indicative of such an event. For example, the PYD 1598/7655 digital pyro mentioned above uses a digital threshold ranging between 0 and Vdd in increments of 6.5 μV/count. The activation distance generally increases as the digital threshold is increased (thereby causing infrared sensor 108 to become less sensitive) and decreases as the digital threshold is decreased (thereby causing infrared sensor 108 to become more sensitive). In one embodiment, using the PYD 1598/7655, Vdd=3 volts, a threshold value of 1.5 volts, and with mask opening 104 1 mm in diameter, the activation distance is approximately 12 inches.

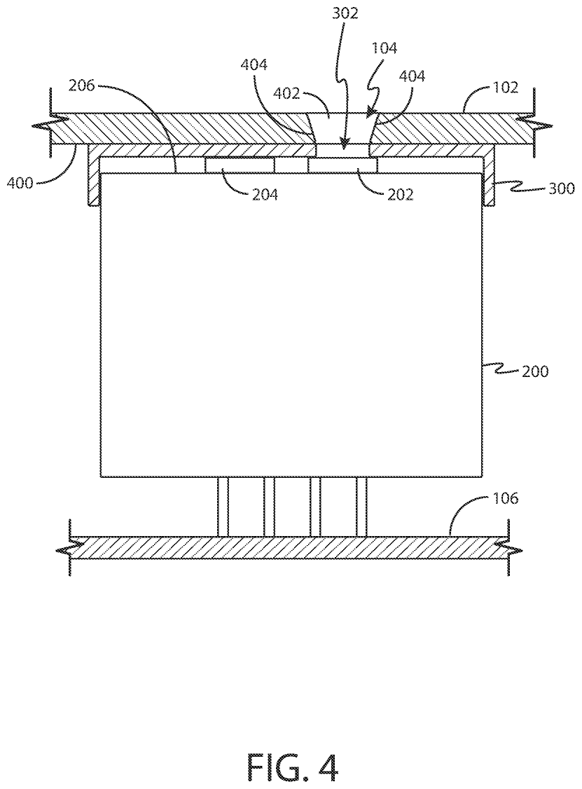

FIG. 4 is an extreme close up, cutaway, side view of one embodiment of electronic device 100, showing one embodiment of infrared sensor 108 mounted to circuit board 106 within housing 102. Two sensing elements 202 and 204 are shown in side view, on top of top surface 206, and masked by mask 300, with element 204 completely masked and element 202 partially masked, with mask aperture 302 positioned over a portion of element 202. The term “partially masked” means that a sensing element is completely covered by mask 300 except for mask opening 302, that allows some light to fall on a sensing element. In the embodiment shown in FIG. 4, mask 300 is attached to infrared sensor 108 as a “sleeve” that may be pushed over top portion 206 of infrared sensor 108. In other embodiments, mask 302 may comprise an IR-resistant/opaque film with a pressure-sensitive adhesive on one or both sides in order for mask 300 to remain situated on top of infrared sensor 108 and in place to partially mask sensing element 202. In another embodiment, mask 300 may be affixed to an inner surface 400 of housing 102 with mask opening 302 aligned with housing aperture 104 such that when circuit board 106 is installed into housing 102, sensing element 202 is brought into substantial alignment with mask opening 302 and housing aperture 102. In the embodiment shown in FIG. 4, mask 300 is very close (within 2 millimeters or so), or touching, inner surface 400 of housing 102 as shown. In general, it is desirable to have infrared sensor 108/mask 300 close or even touching inner surface 400, because ambient light that enters housing 102 via housing aperture 104 is generally restricted from reaching unintended sensing elements, such as element 204.

In the embodiment shown in FIG. 4, the diameter of housing aperture 104, as measured on inner surface 400 of housing 102, is slightly larger than the diameter of mask opening 302, so as to not block any light from reaching the exposed portion of sensing element 202. In other embodiments, the diameter of housing aperture 104, as measured on inner surface 400 of housing 102, is equal to or smaller than at least one dimension of sensing element 202. In some cases, mask 300 may be eliminated when the diameter of housing aperture 104 is used to limit the amount of ambient light that reaches sensing element 202. In these embodiments, infrared sensor 108 is typically mounted to circuitry board 106 very precisely, in x-y position, orientation and height, so that at least a portion of sensing element 202 is in substantial alignment with housing aperture 104 when electronic device 100 is assembled, while at least sensing element 202 abuts or is flush with inner surface 400 around housing aperture 104 (or a very thin cushioning pad in one embodiment mounted to inner surface 400). For example, if sensing element 202 is 2 mm×1 mm, the inner diameter of housing aperture 104 may be 0.9 mm.

Housing aperture 104 is created by forming a hole through housing 102 at a precise location in order to substantially align with sensing element 202/mask opening 302. In many embodiments, housing aperture 104 comprises a beveled edge 404 that allows a greater field of view for sensing element 202 than would otherwise be possible if housing aperture 104 were formed without such beveling. In some embodiments, a “lens” 402 or, more generally, “material” 402, is inserted/deposited into housing aperture 104 in order to prevent dust and other contaminants from entering inside housing 102. Lens/material 402 may comprise a high infrared transmissibility rating that allows infrared light to pass, and a low visible light transmissibility rating in order to reduce or block visible light from entering housing 102. In one embodiment, lens/material 402 is formed from a PIR transmissive window film, such as one manufactured by Kube Electronics AG of Zurich, Switzerland, that passes up to 88% of infrared light, while blocking up to 90% of visible light.

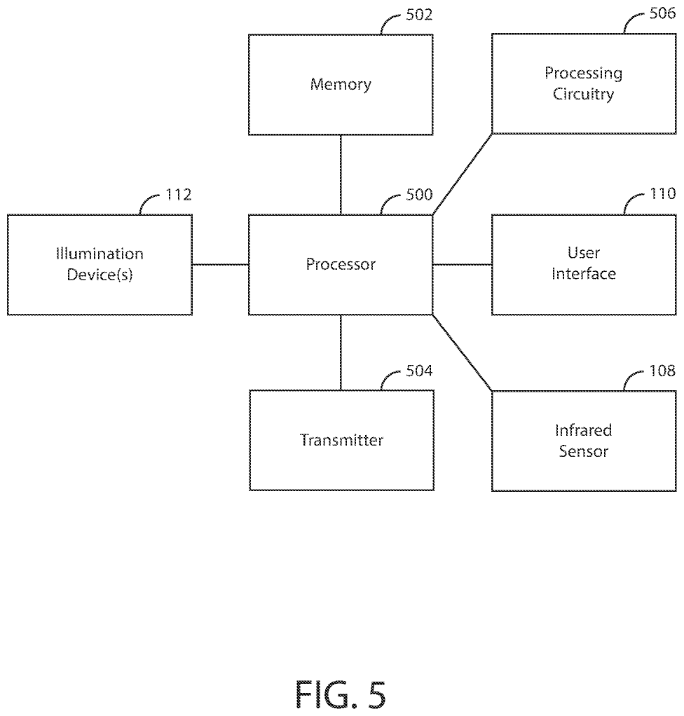

FIG. 5 is a functional block diagram of one embodiment of electronic device 100, shown comprising processor 500, memory 502, transmitter 504, infrared sensor 108, user interface 110, illumination device(s) 112 and processing circuitry 506. It should be understood that in some embodiments, not all of the functional blocks shown in FIG. 5 are necessary for the proper operation of electronic device 100 (for example, transmitter 504 in an embodiment where no transmissions from electronic device 100 are needed, or processing circuitry 506 if infrared sensor 108 is an active, digital pyro-type device containing such processing circuitry) and that some functionality has been omitted for purposes of clarity (such as a battery).

Processor 500 is configured to provide general operation of electronic device 100 by executing processor-executable instructions stored in non-transitory memory 502, for example, executable computer code. Processor 500 typically comprises one or more general or specialized microprocessors, microcontrollers, and/or customized ASICs, selected based on computational speed, cost, and power consumption. In the case of a general microprocessor, processor 500 may become a specialized processor by performing the functions of electronic device 100 and, specifically, a function for determining imminent use of electronic device 100, by executing the instructions stored in memory 202.

Non-transitory memory 502 is coupled to processor 500, comprising one or more non-transitory electronic, digital information storage devices, such as static and/or dynamic RAM, ROM, flash memory, or some other type of electronic, optical, or mechanical memory device. Non-transitory memory 502 is used to store processor-executable instructions for operation of electronic device 100. It should be understood that in some embodiments, a portion of non-transitory memory 502 may be embedded into processor 500 and, further, that non-transitory memory 502 excludes propagating signals.

Transmitter 504 comprises circuitry necessary to transmit wireless signals to one or more other electronic devices, such as a receiver associated with an HVAC equipment, a security panel, a hub, a router, a mobile phone, a computer, etc. Such circuitry is well known in the art and may comprise BlueTooth, Wi-Fi, RF, or cellular circuitry, among others.

Infrared sensor 108 is coupled to processor 500 and has already been described in an embodiment where infrared sensor 108 comprises internal circuitry for amplifying, filtering, digitizing and generating an interrupt when imminent use of electronic device 100 is detected. In another embodiment, infrared sensor 108 comprises a simple pyroelectric sensor that generates a surface electric charge when exposed to heat in the form of infrared radiation. In this embodiment, external processing circuitry 506 is typically needed to determine imminent use of electronic device 100, the processing circuitry comprising such electrical components such as one or more amplifiers, filters, analog-to-digital converters, comparator circuits, etc.

As mentioned previously, infrared sensor 108 may comprise a single sensing element or comprise two or more sensing elements, typically in pairs.

User interface 110 is coupled to processor 500, comprising circuitry and one or more I/O devices such as a keypad, display, touchscreen display, etc., for allowing a user to operate and/or provide/receive information to/from electronic device 100.

Illumination device(s) 112 is/are coupled to processor 500, comprising one or more illumination devices and related circuitry to illuminate electronic device 100 upon detection of imminent use by a user of electronic device 100. For example, electronic device 100 may comprise three LEDs and associated drivers that cause electronic device 100 to self-illuminate when a user's hand approaches electronic device 100 within the activation distance. The one or more illumination devices 112 are typically mounted inside housing 102 such as to illuminate at least user interface 110. Of course, other illumination devices may be used instead of one or more LEDs, as known in the art. In another embodiment, electronic device 100 does not use any illumination devices 112. In this embodiment, user interface 110 comprises self-eliminating components, such as backlit keys in the case of a keypad and a display screen that becomes activated when a user's hand is within the activation distance. In these cases, processor 500 causes a keypad to self-illuminate and/or a display screen to become active when processor 500 determines, from infrared sensor 108, that a user's hand is approaching electronic device 100 within the activation distance.

Processing circuitry 506 is coupled to processor 500, for processing signals from infrared sensor 108 in an embodiment where infrared sensor 108 does not comprise processing circuitry, such as amplifiers, filters, digital-to-analog converters, comparators, etc. Processing circuitry 506 comprises one or more amplifiers, filters, digital-to-analog converters, comparators, etc. as well-known in the art for processing signals from a pyroelectric device to determine whether motion is present. Processing circuitry 506 receives raw signals from infrared sensor 108 and typically amplifies and filters a signal generated by one of the infrared sensors in the case of a multi-channel pyroelectric device. The amplified and filtered signal is then typically compared against a threshold in order to determine if the signal represents a minimum level of detected infrared energy. In one embodiment, processing circuitry 506 comprises an integrated circuit that contains one or more filters, amplifiers, analog-to-digital circuitry and a comparator circuit, such as a MSP430FR2355 integrated circuit, manufactured by Texas Instruments Incorporated of Dallas, Texas.

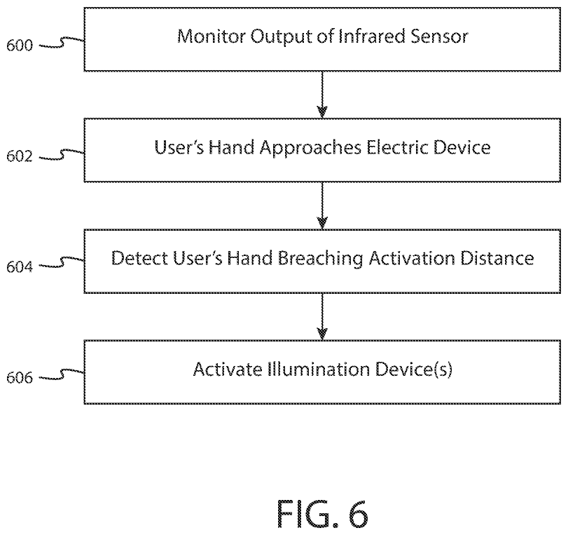

FIG. 6 is a flow diagram illustrating one embodiment of a method, performed by infrared sensor 108 and processor 500, for determining imminent use of electronic device 100, in an embodiment where infrared sensor 108 comprises an active infrared sensor such as the PYD 1598/7655 discussed earlier herein. It should be understood that in some embodiments, not all of the steps shown in FIG. 6 are performed, and that the order in which the steps are carried out may be different in other embodiments. It should be further understood that some minor method steps have been omitted for purposes of clarity.

At block 600, processor 500 monitors an output of infrared sensor 108, typically an “interrupt” line of infrared sensor 108.

At block 602, a person's hand approaches electronic device 100 as the person reaches for user interface 110 of electronic device 100, typically in order to enter information into electronic device 100.

At block 604, infrared sensor 108 detects when the person's hand is approaching electronic device 100 and has breached a predefined activation distance from electronic device 100. The activation distance is set to a relatively short distance, for example 12-24 inches, so that electronic device 100 is not activated by the person merely walking past electronic device 100. The activation distance is set at least in part by an area of mask opening 302 in relation to an area of a respective infrared sensing element of infrared sensor 108. When infrared sensor 108 determines that the person's hand is approaching electronic device and breaches the activation distance, infrared sensor 108 generates a signal indicative of imminent use of electronic device 100. In one embodiment, the signal isn't interrupt generated by electronic device 100 and provided to processor 500.

At block 606, in response to receiving the signal from infrared sensor 108, processor 500, in response, activates one or more illumination devices 112 or, in an embodiment that does not utilize them illumination devices, causes at least a portion of user interface 110 to illuminate. In another embodiment, processor 500 may perform an additional, or alternative, action, such as to send a message via transmitter 504 to a remote receiver, indicating that imminent use of electronic device 100 was detected, illuminating or turning off a light, etc.

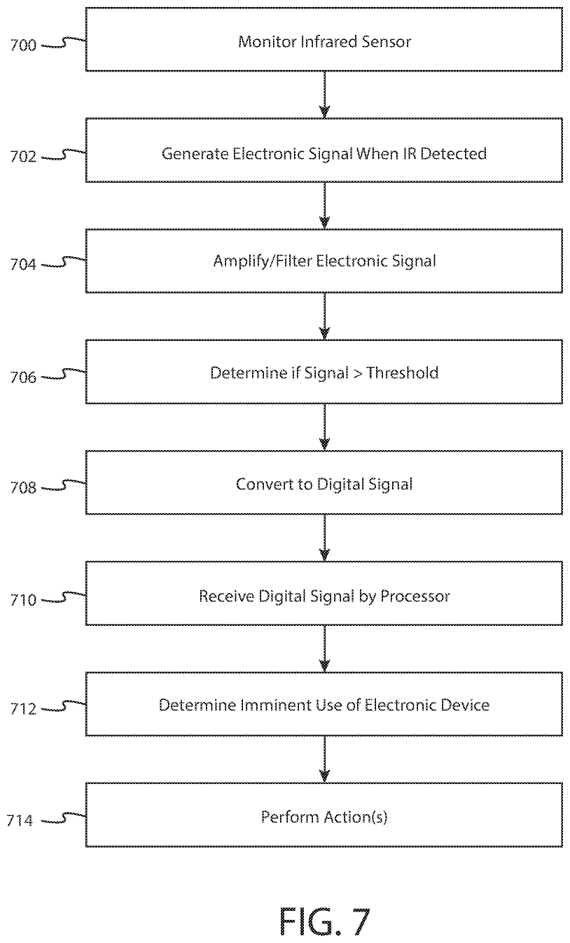

FIG. 7 is a flow diagram illustrating one embodiment of a method, performed by processor 500, for determining imminent use of electronic device 100, in an embodiment where infrared sensor 108 comprises a pyroelectric sensor without active components. It should be understood that in some embodiments, not all of the steps shown in FIG. 7 are performed, and that the order in which the steps are carried out may be different in other embodiments. It should be further understood that some minor method steps have been omitted for purposes of clarity.

At block 700, processing circuitry 506 monitors an output of infrared sensor 108, i.e., a raw, analog electrical signal produced as a result of a surface electric charge generated when infrared sensor 108 is exposed to heat in the form of infrared radiation. Such a signal is on the order of microvolts. An infrared sensing element of infrared sensor 108 is partially masked by mask 300, while one or more other sensing elements of infrared sensor 108, if any, are completely covered by mask 300 or by a portion of housing 102.

At block 702, as a person's hand approaches electronic device 100 an analog electronic signal is generated by the partially-masked infrared sensing element of infrared sensor 108. The amplitude of the analog electronic signal increases as the person's hand gets closer to electronic device 100 and infrared sensor 108. However, the amplitude of the electronic signal typically is not significant until the person's hand crosses the activation distance, due to masking of at least one sensing element of infrared sensor 108. For example, the voltage of the electronic signal from the partially-masked infrared sensing element may remain less than 500 microvolts outside the activation distance, even when a source of infrared energy moves in the field of view of infrared sensor 108. As the person's hand moves toward electronic device 100 and crosses the activation distance, the voltage of the electronic signal may increase past 500 microvolts.

At block 704, the analog electronic signal from infrared sensor 108 is received by processing circuitry 506, such as one or more common analog filters to reduce unwanted noise and one or more microelectronic amplifiers to increase a signal-to-noise ratio of the analog electronic signal.

At block 706, the amplified and filtered signal may be provided to a comparator circuit of processing circuitry 506, for determining if the electronic signal is greater than a comparator voltage threshold, indicative of movement of the person's hand towards electronic device 100 within the activation distance.

At block 708, the output of the comparator may be provided to an analog-to-digital converter (ADC) of processing circuitry 506, for converting the output of the comparator into a digital signal. The output of the ADC can be provided to processor 500.

At block 710, processor 500 receives the digitized signal from processing circuitry 506.

At block 712, processor 500 determines whether one or more digital signals from processing circuitry 506 indicates movement of a person's hand towards electronic device 100 within the activation distance. In one embodiment, processor 500 determines imminent use of electronic device 100, i.e., that a person's hand is moving towards electronic device 100 within the activation distance, when it receives a single digital signal from processing circuitry 506. In other embodiments, imminent use is determined when processor 500 receives two or more digital signals from processing circuitry 506 within a predetermined time period, such as 10 signals within 1 second.

At block 714, in response to determining imminent use of electronic device 100, processor 500 activates one or more illumination devices 112 or, in an embodiment that does not utilize them illumination devices, causes at least a portion of user interface 110 to illuminate. In another embodiment, processor 500 may perform an additional, or alternative, action, such as to send a message via transmitter 504 to a remote receiver, indicating that imminent use of electronic device 100 was detected, illuminating or turning off a light, etc.

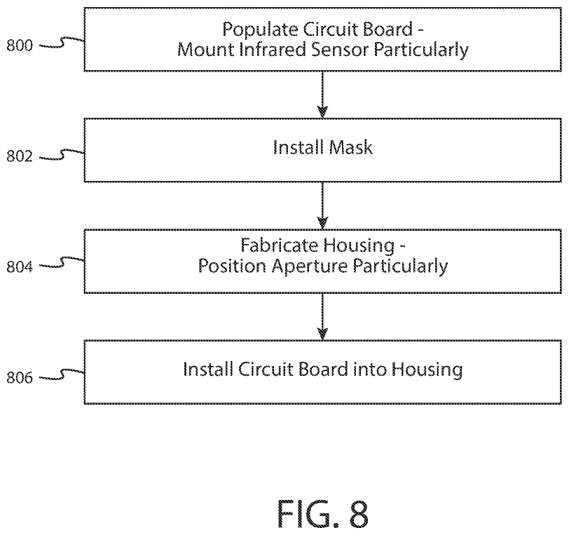

FIG. 8 is a flow diagram illustrating one embodiment of a method for manufacturing electronic device 100. It should be understood that in some embodiments, not all of the steps shown in FIG. 8 are performed, and that the order in which the steps are carried out may be different in other embodiments. It should be further understood that some minor method steps have been omitted for purposes of clarity.

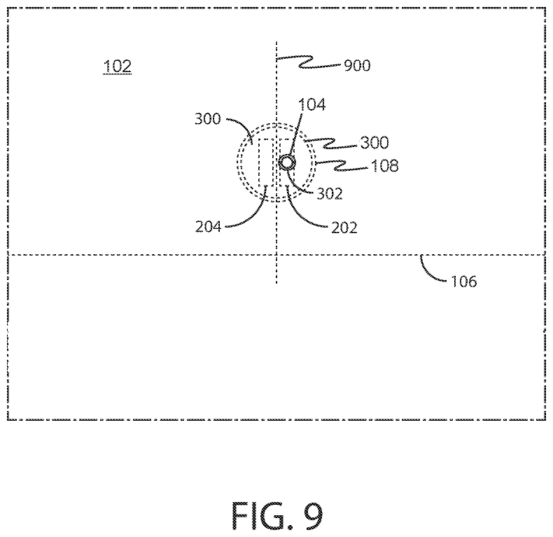

At block 800, circuit board 106 is populated with a plurality of components, including infrared sensor 108 having at least one sensing element. In one embodiment, infrared sensor 108, or at least one sensing element of infrared sensor 108, is positioned on circuitry board 106 such that it will be in substantial alignment with housing aperture 104 of housing 102 once electronic device is fully assembled. This may require relatively tight tolerances, such as less than 0.5 mm or less, due to the small size of a typical sensing element, such as 1 mm×2 mm (in an embodiment where sensing element is rectangular) and the small size of housing aperture 104. In some embodiments, where infrared sensor 108 comprises a two or more sensing elements, but only one sensing element used to detect an approaching human hand, infrared sensor 108 may, in addition to be located particularly on circuit board 106 within a tight tolerance, also be oriented in a particular way as to align one of the sensing elements with housing aperture 104. For example, as shown in FIG. 9, infrared sensor 108 comprises two sensing elements 202 and 204 (with sensing element 204 completely hidden by mask 300 and sensing element 202 mostly hidden by mask 300 except for mask opening 302 that allows some ambient light in front of electronic device 100 to fall on a limited portion of sensing element 202) though opening 302. Infrared sensor is installed onto circuit board 106 using traditional soldering techniques, placed on circuit board 106 at a particular location, within a tight tolerance, so that sensing element 202 is in substantial alignment with housing aperture 104. Further, because infrared sensor 108 in this embodiment comprises two, offset sensing elements, it may be necessary to additionally orient infrared sensor 108 such that a length of the sensing elements is parallel to an imaginary longitudinal axis 900 that runs vertically and perpendicular to an upper edge 902 and a lower edge 904 of circuitry board 106, as shown. In some embodiments, the height of infrared sensor 108 from circuit board 106 is tightly controlled so that at least a portion of one sensing element of infrared sensor 108 is within a short, predetermined distance from inside surface 400 of housing 102, such as within 0.5 mm, or flush against housing aperture 104, to limit/prevent ambient light from reaching other sensing elements of infrared sensor 108. Thus, only when infrared sensor 108 is installed in a particular location on circuitry board 106, oriented correctly, and mounted at a certain height, will mask opening 302 align with housing aperture 104, in some embodiments.

At block 802, at least a portion of at least one sensing element of infrared sensor 108 is blocked by installing mask 300 comprising mask opening 302. The area of mask opening 302 relative to an area of sensing element of infrared sensor 108 limits an amount of ambient light that reaches the masked sensing element. In one embodiment, where infrared sensor 108 comprises two or more sensing elements, mask 300 completely blocks light from reaching all but one of the sensing elements, and partially blocks one of the sensing elements, allowing some light to reach the partially-blocked sensing element through mask opening 302. The size of opening 302 may directly affect a sensitivity of infrared sensor 108 to an approaching human hand and may proportionally define the activation distance. For example, the larger opening 302, the more sensitive infrared sensor becomes and vice-versa. Thus, the activation distance may vary with respect to the size of opening 302. Mask 300 may be affixed to infrared sensor 108 or to inner surface 400 of housing 102 around housing aperture 102.

At block 804, housing 102 is fabricated, typically using an injection-molding process. Housing aperture 104 is formed into a front surface of housing 102 at a location that will align with at least a portion of infrared sensor 108 when electronic device 100 is fully assembled. Housing aperture 104 is typically beveled, or “sloped”, to maximize a field of view of infrared sensor 108. In one embodiment, the size of opening 102 may affect the sensitivity of infrared sensor 108 if opening 102 is smaller than the size of a sensing element of infrared sensor 108. Similar to mask opening 302, the small housing aperture 104, the less sensitive infrared sensor 108 is and the shorter the activation distance.

At block 806, circuit board 106 is installed into housing 102, where at least one sensing element of infrared sensor 108 is in substantial alignment with housing aperture 104 due to the particular placement and, in some embodiments, orientation, of infrared sensor 108 on circuit board 106 and the location of housing aperture 104 on housing 102.

The methods or steps described in connection with the embodiments disclosed herein may be embodied directly in hardware or embodied in machine-readable instructions executed by a electronic circuit, or a combination of both. The machine-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the electronic circuit such that the electronic circuit can read information from, and write information to, the storage medium. In the alternative, the storage medium may be integral to the electronic circuit. The electronic circuit and the storage medium may reside in an ASIC. In the alternative, the electronic circuit and the storage medium may reside as discrete components.

Accordingly, an embodiment of the invention may comprise a non-transitory electronic circuit-readable media embodying code or machine-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. An electronic device, comprising:
a infrared sensor for detecting a change of infrared energy within an activation distance from the electronic device, the activation distance comprising a distance where a user's hand is detected as it approaches the electronic device;
a processor coupled to the infrared sensor, for receiving an electronic signal from the infrared sensor indicative of the change of infrared energy, for determining that the electronic signal comprises an indication of imminent use of the electronic device, and for activating an illumination device in response thereto; and
the illumination device, coupled to the processor, for illuminating the electronic device when the processor has determined imminent use of the electronic device.

2. The electronic device of claim 1, wherein the activation distance is less than 18 inches.

3. The electronic device of claim 1, further comprising:
a mask mounted over the infrared sensor, the mask comprising a mask opening for limiting an amount of ambient light that reaches the infrared sensor.

4. The electronic device of claim 3, wherein a size of the mask opening is proportional to the activation distance.

5. The electronic device of claim 3, wherein an area of the mask opening and an area of a sensing element of the infrared sensor defines the activation distance.

6. The electronic device of claim 3, wherein the infrared sensor comprises two or more sensing elements, wherein the mask completely covers all but a first sensing element of the two or more sensing elements and partially covers the first sensing element via the mask opening.

7. The electronic device of claim 1, further comprising:
a housing that encloses the infrared sensor and the processor, the housing comprising a housing opening in substantial alignment with the infrared sensor for allowing ambient light to fall onto the infrared sensor.

8. The electronic device of claim 7, wherein the infrared sensor comprises a sensing element, wherein the housing opening is smaller than an area of the sensing element.

9. The electronic device of claim 8, wherein the infrared sensor comprises two or more sensing elements, wherein the housing aperture is positioned over a first of the two or more sensing element only.

10. The electronic device of claim 9, wherein the two or more sensing elements are substantially flush against an inner surface of the housing.

11. The electronic device of claim 7, further comprising:
a lens deposited into the housing opening comprising a material with a high infrared transmissibility rating and a low visible light transmissibility rating.

12. The electronic device of claim 1, further comprising:
electronic circuitry coupled to the processor to internally filter and amplify an internal electrical signal generated by the passive infrared sensor in response to the increase in infrared energy.
wherein the infrared sensor comprises a passive, pyroelectric sensor

13. The electronic device of claim 1, wherein the infrared sensor comprises one or more passive infrared sensing elements and active electrical components, the active electrical components for processing signals produced by a first one of the passive infrared sensing elements, for determining when infrared energy sensed by the first passive infrared sensing element indicates imminent use of the electronic device, for generating an interrupt signal when imminent use of the electronic device is determined, and for providing the interrupt to the processor that indicates imminent use of the electronic device.

14. A method for determining imminent use of an electronic device using a digital infrared sensor, comprising:
limiting an amount of ambient light that falls on the infrared sensor with a mask, the mask comprising a mask opening that allows some ambient light to fall on a first sensing element of the infrared sensor, the mask opening sized to define an activation distance in front of the electronic device that, when breached by a human hand, causes an electronic signal to be generated by the infrared sensor;
receiving the electronic signal by the processor; and
in response to receiving the electronic signal, causing one or more illumination devices to illuminate the electronic device.

15. A method for determining imminent use of an electronic device using a passive pyroelectric sensor, comprising:
limiting an amount of ambient light that falls on the passive pyroelectric sensor with a mask, the mask comprising a mask opening that allows some ambient light to fall on the passive pyroelectric sensor, the mask opening sized to define an activation distance in front of the electronic device that, when breached by a human hand, causes the electronic device to become illuminated;
generating an electric signal by the passive pyroelectric sensor in response to detecting a change in infrared energy;
amplifying the electric signal to form an amplified signal;
filtering the amplified electric signal to create a filtered signal;
comparing the filtered signal to a threshold;
determining that a human hand has breached the activation distance when the filtered signal exceeds the threshold; and
in response to determining that the human hand has breached the activation distance, causing one or more illumination devices located on or within the electronic device to illuminate the electronic device.
